(19) United States
(12) Patent Application Publication
(10) Pub. No.: US 2017/0324695 A1
(43) Pub. Date: Nov. 9, 2017

(54) AUTOMATED MONITORING OF ELECTRONIC MESSAGING FOR TIMED ALERTS OF PREVIOUSLY TRANSMITTED MESSAGES

(71) Applicant: PAYPAL, INC., San Jose, CA (US)

(72) Inventors: Ralf Horst Fischer, Berlin (DE); Matthias Patrick Rosch, Berlin (DE)

(21) Appl. No.: 15/150,232

(22) Filed: May 9, 2016

(51) Int. Cl. H04L 12/58; H04L 29/12

(52) U.S. Cl. CPC H04L 51/24; H04L 51/04; H04L 61/307

(57) ABSTRACT

There are provided systems and methods for automated monitoring of electronic messaging for timed alerts of previously transmitted messages. A sender may transmit an electronic communication to a recipient, where the sender activates an automated timer application to track the viewing and/or response of the communication by the recipient. The application may establish a timer having a set time period of the recipient to respond to the communication. If the recipient fails to respond, view, or otherwise acknowledge the communication by the end of the timer, the application may send an alert to the recipient to remind the recipient of the communication. The recipient and sender may establish preferences for the timer and the alert with the application. Moreover, the application may determine the timer based on the urgency of the communication, as well as determine where and when to send the alert based on recipient information.

### TECHNICAL FIELD

The present application generally relates to automated application bots for electronic messaging, and more specifically to automated monitoring of electronic messaging for timed alerts of previously transmitted messages.

### BACKGROUND

Users may utilize electronic messaging to communicate with other users, for example, through email, text messaging, instant messaging, online social networking, or other electronic communication protocol or medium. Often, the electronic communications include messages that require acknowledgement, viewing, and/or response. In this regard, the users may utilize the messages for work purposes, or to transmit time sensitive material that may require the recipient to resolve or respond to the received message. At other times, the messages may not be time sensitive, but may require follow-up, such as the start of a project or to answer some query of another user. However, traditionally users have been required to flag these messages or manually implement a tracking mechanism to respond to the messages. Thus, if a recipient misses a message or forgets the content or reply request of a message, the sender may be required to follow-up with the recipient, which wastes time and may lead to unwanted communications by both parties. Moreover, the sender may not want to upset the recipient by requesting a response too early, or may similarly forget about the sent communication, thereby causing potential errors and lack of expediency in resolving the matter of the communication.

### BRIEF DESCRIPTION OF THE DRAWINGS

FIG. 1 is a block diagram of a networked system suitable for implementing the processes described herein, according to an embodiment;

FIG. 2 is an exemplary environment displaying application interfaces for automated monitoring of electronic messaging for timed alerts of previously transmitted messages, according to an embodiment;

FIG. 3 is an exemplary system environment having a multiple communication devices and a service provider for automated monitoring of electronic messaging for timed alerts of previously transmitted messages, according to an embodiment;

FIG. 4A is an exemplary process flowchart for automated monitoring of electronic messaging for timed alerts of previously transmitted messages for a recipient, according to an embodiment;

FIG. 4B is an exemplary process flowchart for automated monitoring of electronic messaging for timed alerts of previously transmitted messages for a sender, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for automated monitoring of electronic messaging for timed alerts of previously transmitted messages. Systems suitable for practicing methods of the present disclosure are also provided.

An online service provider may provide electronic communication and messaging services to users of the online service provider. For example, email, instant messaging, social networking, media sharing, and other online resources may provide various types of electronic messaging to users. Additionally, other types of service providers may provide messaging, such as telecommunication service providers, which may provide text and voice messaging services (e.g., SMS, MMS, telephonic messaging, etc.). In other embodiments, the service provider may provide payment processing, monetary transfer, and other financial services to merchants, consumers, and other users, which may be utilized through one or more applications executing on a user device of the user. The service provider may further include additional transaction management services, as well as account services for use with the service provider and accessible through a device application, such as a browser application, dedicated application of the service provider, and/or other application (e.g., merchant application) utilizing the processes and features provided by the service provider. Accounts with the service provider may correspond to user messaging accounts, where a holder of the account may send and receive electronic messages with other users, as well as engage in other account services. For example, payment accounts with a payment provider may allow a user to send and receive money for transactions, transfers, and other financial actions. The accounts of users may include personal, device, and financial information, as well as other information that may be determined by or requested from the service provider. Additionally, the user may specify authentication credentials, such as a login name, password, and/or personal identification number (PIN) for use of the account. The service provider may further provider communication alert services through a timer and reminder feature, for example, through one or more applications and/or processes of the service provider.

A first user (e.g., a sender) may prepare and send an electronic message, such as an email, text message, instant message, social networking message or post, or other type of message through a messaging protocol, to a second user (e.g., a recipient). The electronic message may be sent using the service provider, for example through an account of the sender provided by the service provider. The electronic message may include message content, such as text, audio, visual, and/or audiovisual content for the recipient. Moreover, the message may be addressed to the recipient from the sender, for example, using a “To:” field or other address field of the message. The message may include another field, such as a carbon copy or “cc:” field, where the sender may address other users, or the sender may utilize the “To:” address field. When addressing the message to the recipient, the sender may include an address for the online service provider, which may correspond to a general address or a specific address for the service provider's communication alert services (e.g., an address specific to a timer the sender would like to implement). For example, an electronic address may act as a timer activation command for the communication alert services, as discussed herein. In other embodiments, the reference to the timer activation command may be made in the body or content of the message, or may be omitted in various embodiments where the online service provider determines whether to set a timer and alert based on the sent message, as discussed herein.

The recipient may utilize their respective account with the service provider to receive the electronic message. The recipient's account with the service provider may be utilized by the recipient to view and respond to messages, including the electronic message from the sender. In this regard, the account may include received messages, which may allow the recipient to receive and view the message. After opening and viewing the message, the service provider may initiate a timer based on a timer activation command, message, and/or message content, as described herein. However, in other embodiments, the recipient may not view the message (e.g., they may fail to open, read, or otherwise acknowledge the message). In such cases, the service provider may still establish and begin a timer based on the time initiation command, message, and/or message content, as described herein. The recipient may utilize the account to further transmit one or more additional electronic messages, such as a reply to the message sent from the sender.

Thus, the service provider may utilize one or more processes for features to provide timers to alert the recipient to respond or otherwise acknowledge the received electronic message from the sender. Thus, the service provider may monitor sent electronic communications of the sender and received electronic communications of the recipient. In various embodiments, the service provider may monitor all incoming and outgoing electronic communications of the sender and recipient. The sender and/or the recipient may be required to opt-in to monitoring of sent and received electronic communications for the sender and/or recipient, especially where the service provider is remote or a separate entity from the messaging service used by the sender and/or recipient. However, in other embodiments, the communication monitoring and alert services may be automatically provided by the service provider, for example, in response to the sender and/or receiver utilizing the service provider and/or a messaging service of the service provider. The service provider may establish and begin a timer where the service provider detects an electronic message in the communications of the sender and/or recipient having a timer activation command. For example, by adding an email address for the service provider or an email address specifically targeted to the communication alert services of the service provider (e.g., in an address field of the message), the service provider may receive the electronic message and may set and initiate a timer. In other embodiments, the service provider may not directly receive the message, and may instead monitor all communications to detect if the timer activation command is added to the subject line, body, and/or signature line of the electronic message. In such embodiments, the service provider may detect the timer activation command and set/initiate a timer. Once a timer is initiated, the timer may begin a countdown for a set time period, where the recipient may be required to follow-up, reply, or otherwise acknowledge the received electronic message. If the recipient responds to the message from the sender (e.g., sends a message back to the sender, forwards the message to another party, views the message, etc.), the service provider may then end the timer. However, the recipient may also request, for example, through preferences and/or another electronic message, that the service provider instead continue the timer or extend or otherwise adjust the timer, even after providing a response or other acknowledgement. In other embodiments, the sender may be required to further follow-up, based on preferences for the timer set by the sender and/or recipient.

The service provider may determine whether to establish a timer based on the content, urgency, escalation, number of associated messages, and/or other information including user information about the recipient. For example, the service provider may perform predicative analysis on the content and/or urgency status of the message (e.g., whether the content is marked confidential, urgent, time sensitive, etc. or whether the message includes a flag or marker as urgent, reply request, etc.). In such embodiments, the content/status may act as a timer activation command, where the service provider may establish a timer based on such information. In other embodiments, the message may not immediately be associated with a timer. However, if the message goes ignored, unacknowledged, or un-replied for a period of time, or follow-up messages are sent from the sender or another party, the service provider may establish and begin a timer based on the escalation of the original and any subsequent messages and/or the number of received messages directed to the same message chain and/or subject received by the recipient. In certain embodiments, user information for the recipient may be used to set a timer for an alert and reminder. For example, if the recipient is known to be travelling, vacationing, in a meeting, or otherwise unlikely to view and/or reply to a message, the service provider may set a timer for the received message from the sender based on when the recipient is likely to first able to access the message, such as after the meeting ends or the recipient lands from a flight. Such user information may be entered by the recipient, or may be determined based on recipient location (e.g., detected through a GPS locator), transaction history of purchases, calendar of appointments (e.g., through a calendaring application and/or electronic communication stream), or other resources. In certain embodiments, the user information may be scraped from one or more online resources, such as an online social networking provider.

Where the recipient does not respond or otherwise acknowledge the electronic message from the sender by the expiration of the timer (e.g., by the end of the time period for the timer), the service provider may generate and transmit an electronic alert to the recipient to remind the recipient of the message and/or the requirement or request of response to the message. The electronic alert may correspond to another electronic message, or may include an application badge, icon, interface, notification, etc. In further embodiments, the electronic alert may correspond to a message, communication, notification, or alert through another communication protocol, such as text message (SMS/MMS), public switched telephone network (PSTN, such as a phone call or voice message), email, or other communication medium. The type of electronic message may be specified by the recipient and/or sender, or may be determined based on predictive analysis of what protocol is most likely to reach the recipient and/or sender, as discussed herein. The type of message may correspond to the protocol for the received electronic message creating the timer, or may correspond to another communication protocol. Moreover, in various embodiments, not such the sender and/or recipient may receive the electronic alert. For example, a supervisor for the recipient may receive the electronic alert at the expiration of the timer. In various embodiments, if the recipient receives an electronic alert for lack of response to the message from the sender, another timer may be initiated for a further alert. In such embodiments, the supervisor may only be informed after multiple missed reply periods and/or lack of response to the electronic alert, for example, if the recipient fails to respond over three time periods and three alerts are sent to the recipient. In further embodiments, a related third party, such as a client, staff member, or other party may further receive the alert.

In various embodiments, the sender and/or recipient may establish preferences with the service provider for the timer (e.g., timer specific preferences) and/or timers in general (e.g., global timer preferences for all or a subset of established timers). The preferences may correspond to one or more of a time period for the time (e.g., 1 weeks, 1 day, 12 hours, 1 hour, 15 minutes, etc.), an initial number of timers to set (e.g., initially establish 1 timer, 3 timers with different time periods, etc.), a number of subsequent timers after expiration of the initial timer (e.g., ongoing, for 1 week, for 1 day, etc.), a destination device and/or destination account for an electronic alert, a type or protocol for the electronic alert, a supervisor or third party to additional alert, whether the sender will further receive an alert, and/or any other type of preference. In order to access and set the preferences, a link, such as a Uniform Resource Locator (URL) or hyperlink, may be added to the electronic message by the sender and/or service provider. The link may go to a website or application portal/interface that allows the recipient to set the preferences. The link may be specific to the message having the link, or may be general for global preferences. Thus, the recipient may be required to login or provide an identifier to set their preferences. The sender may similarly access the preferences through the link. In other embodiments, the service provider may provide the website for access through the sender/recipients account to change the preferences, or through a dedicated application of the service provider. Moreover, the preferences may also be added to the electronic message by the sender, or may be transmitted to the service provider in a reply message by the recipient to the received electronic message from the sender.

In other embodiments, the preferences may be determined by the service provider based on the content, urgency, and/or message metadata (e.g., number of messages in the message chain, escalation of previous un-replied messages, etc.). Thus, the service provider may set the timer for the reminder based on the content, urgency, and/or escalation level of the received message by the recipient. For example, if the content of the electronic message sent by the sender to the recipient includes a due date, time to reply, or other data, the service provider may establish the timer and/or time period for the timer based on the content of the electronic message. Such determinations may be made based on text analysis, as well as image, audio, and other content based analysis. In such embodiments, the message subject line, content, and/or signature may note a time to reply, or a time to reply may be inferred (e.g., where a document notes a validity date, due date, etc.).

Additionally, preferences for a type/protocol for the electronic alert, as well as a destination device or account, may be determined by the service provider. Thus, the service provider may analyze user information, as well as device and account data to determine the aforementioned information. In this regard, the user information may include a location of the recipient, receipts and transaction histories for the recipient, recent online activity, biometric, or other user actions and information that may be used to determine a best process to alert and/or contact the recipient. For example, if the recipient is currently or recently using a payment account through a payment account, an instant message through the payment application may be the best way to contact the recipient. In other embodiments, account and/or device use may indicate the best destination device and/or account to reach the recipient. Preferences for the sender may similarly be determined by the service provider.

The recipient and/or sender may further cancel the timer. For example, the sender and/or recipient may meet face to face and discuss the matter of the electronic message. In such embodiments, the sender and/or recipient may wish to cancel the timer. The sender and/or recipient may transmit a follow-up message, which may include an identifier, subject line, and/or content from the original electronic message, requesting that the service provider cancel the timer (e.g., a cancelation command, which may include code or other executable command) In certain embodiments, the follow-up message may be sent to another address of the service provider that effectuates cancellations of timers. In certain embodiments, the follow-up message may instead include adjustments of the timer, for example, to extend the timer or otherwise change the time period, or to set a destination account/device or type of electronic alert. Additionally, the sender and/or recipient may access a website or utilize a dedicated application to view set timers and adjust and/or cancel the timers.

The service provider may further tag messages utilizing the communication alert services of the service provider. The messages and/or any alerts or follow-up messages may be tagged together into a message chain. The service provider may provide for collecting similarly tagged messages, as well as archiving and storage of such messages. Thus, the service provider may be utilized by the sender and/or recipient to store, search, and/or retrieve previous messages, as well as set timers and sent alerts by the service provider. Thus, the service provider and/or applications executing on the devices of the user may act as bot or other automated service, which may determine, set, and execute timers in an automated process on receiving an electronic message or otherwise being linked to or detecting an electronic messaging having an initiation to execute a timer. For example, electronic communications, such as email, instant messaging, and text messages, may become lost, undelivered, or a device providing such communications may become inoperable (e.g., lack of signal or battery, damage to the device, theft or loss of the device, etc.). In order to automatically remind users of the communications, the service provider may utilize code, address fields, and other data contained in the communications to generate and execute timers to send electronic alerts and reminders to such digital accounts. In this regard, the service provider and applications executing on the device address such issues with network, Internet, and other electronic communications by providing automated timers through executable bots and other coded applications.

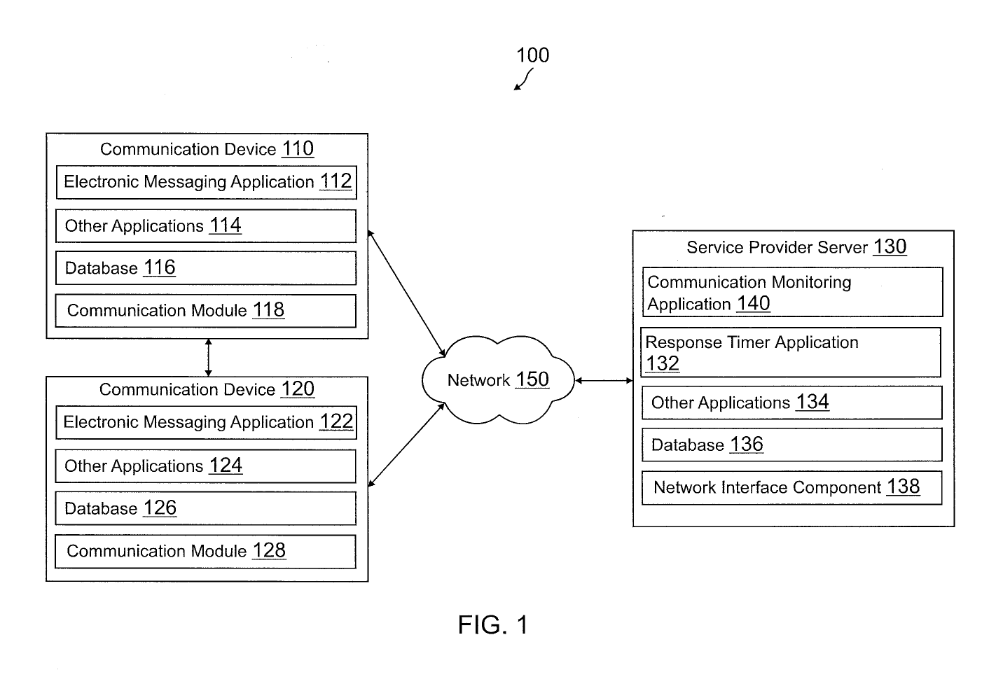

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a communication device 110, a communication device 120, and a service provider server 130, in communication over a network 150. A first user (not shown) may utilize communication device 110 to send an electronic message to a second user (not shown) through communication device 120. Thus, communication device 110 and communication device 120 may be used to send and receive electronic communications with one or more other entities. The electronic communications may be transmitted using network communications and/or short range wireless communications. Service provider server 130 may be utilized to monitor and/or receive the electronic communications and establish timers for follow-up alerts for sent and/or received electronic communications by communication device 110 and communication device 120. For example, service provider server 130 may establish a timer for the electronic message from communication device 110 to communication device 120. On expiration of the timer, service provider server 130 may transmit an alert associated with the electronic message to one or more of communication device 110 and communication device 120.

Communication device 110, communication device 120, and service provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Communication device 110 may be implemented as a communication device that may utilize appropriate hardware and software configured for wired and/or wireless communication with communication device 120 and/or service provider server 130. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Communication device 110 may be utilized by a sender of an electronic message from communication device 110 to communication device 120. Although a communication device is shown, the communication device may be managed or controlled by any suitable processing device. Although only one communication device is shown, a plurality of communication devices may function similarly.

Communication device 110 of FIG. 1 contains an electronic messaging application 112, other applications 114, a database 116, and a communication module 118. Electronic messaging application 112 and other applications 114 may correspond to executable processes, procedures, and/or applications with associated hardware. In other embodiments, communication device 110 may include additional or different modules having specialized hardware and/or software as required.

Electronic messaging application 112 may correspond to one or more processes to execute modules and associated devices of communication device 110 to generate, send, receive, and/or reply to electronic communications, as well as establish timers for alerts to electronic communications and receive such alerts. In this regard, electronic messaging application 112 may correspond to specialized hardware and/or software utilized by communication device 110 to provide an interface to permit a user (e.g., the sender) associated with communication device 110 to generate an electronic message for transmission to communication device 120, such as an email, text message, instant message, message through a social networking service or other online platform, or through another communication protocol, service, and/or technology (e.g., short range wireless communications using a communication protocol such as Bluetooth, Bluetooth low energy, etc.). Electronic messaging application 112 may transmit generated messages using one or more communication protocol and communication pathway, such as network communications and/or short range wireless communication. Electronic messaging application 112 may also receive messages from one or more other entities, including new electronic messages from communication device 120, replies to previous messages from communication device 120, and/or alerts from service provider server 130. Electronic messaging application 112 may be implemented as a user interface enabling the user to enter user input to generate, view, and/or respond to received electronic communications. Electronic messaging application 112 may correspond to a specific communication technology, such as email, text messaging, etc. However, in other embodiments, electronic messaging application 112 may utilize a plurality of different communication protocols and technologies, and gather different types of received electronic communications. In various embodiments, electronic messaging application 112 may correspond to a general browser application configured to retrieve, present, and communicate information over the Internet (e.g., utilize resources on the World Wide Web) or a private network. For example, electronic messaging application 112 may provide a web browser, which may send and receive information over network 150, including retrieving website information, presenting the website information to the user, and/or communicating information to the website, including electronic communications and associated information. However, in other embodiments, electronic messaging application 112 may include a dedicated application of service provider server 130 or other entity (e.g., a merchant, payment provider, etc.), which may be configured to send and receive electronic communications. Electronic messaging application 112 may be utilized to establish and/or maintain a user account, payment account, digital wallet, and/or other online with service provider server 130.

As discussed herein, electronic messaging application 112 may further be used to establish a timer for use in reminding a sender of communication device 110 and/or recipient of communication device 120 of a sent electronic message from communication device 110 to communication device 120. For example, if the recipient of communication device 120 fails to respond, view, or otherwise acknowledge the electronic message by the end of a timer, the recipient may be notified through an alert to communication device 120. In various embodiments, the sender of communication device 110 may also be notified. In order to establish the timer, including preferences for the specific timer and/or a plurality of timers, the sender may provide a timer initiation command in the electronic message generated by the sender using electronic messaging application. The timer initiation command may correspond to a network address, such as an email address, messaging name, Uniform Resource Location (URL), or other identifier for service provider server 130, including a token identifying service provider server 130. The timer initiation command may be placed in an address field, subject line, body, signature line, and/or attachment of the message. Service provider server 130 may process the message and/or timer initiation command, as discussed herein.

In various embodiments, the message may be directly sent to service provider server 130 for processing and transmission to communication device 120. However, more generally, any communication pathway may be used to transmit the message, including network communications and short range wireless communications, where service provider server 130 further monitors and/or receives the message through communication monitoring of communication device 110 and/or communication device 120. Electronic messaging application 112 may further be used to set preferences for the timer for the message and/or for a plurality of timer, for example, using an online website and/or portal and application interface. In other embodiments, electronic messaging application 112 may receive user input for user information and/or determine user information for preferences, and transmit the user information to service provider server 130. Electronic messaging application 112 may be utilized to alert the sender of communication device 110 through a received alert from service provider server 130. The alert may be sent using a communication protocol and pathway, as explained herein.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 150, or other types of applications. Other applications 114 may also include additional communication applications where not provided by electronic messaging application 112, such as email, texting, voice, and IM applications that allow a user to send and receive emails, calls, texts, and other notifications through network 150. In various embodiments, other applications 114 may include financial applications, such as banking, online payments, money transfer, or other applications. Other applications 114 may also include other location detection applications, such as a mapping, compass, and/or GPS application, which may be used to determine a location for the user that is communicated to payment provider server 130. Other applications may include social networking applications and/or merchant applications. Other applications 114 may include device interfaces and other display modules that may receive input and/or output information. For example, other applications 114 may contain software programs, executable by a processor, including a graphical user interface (GUI) configured to provide an interface to the user.

Communication device 110 may further include database 116 stored to a transitory and/or non-transitory memory of communication device 110, which may store various applications and data and be utilized during execution of various modules of communication device 110. Thus, database 116 may include, for example, IDs such as operating system registry entries, cookies associated with electronic messaging application 112 and/or other applications 114, IDs associated with hardware of communication device 110, or other appropriate IDs, such as IDs used for payment/user/device authentication or identification. Database 116 may include electronic communications, including sent and received messages having timers and alerts received on expiration of set timers, which may be received from communication device 120 and/or service provider server 130.

Communication device 110 includes at least one communication module 118 adapted to communicate with communication device 120 and/or service provider server 130. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Communication device 120 may be implemented as a communication device that may utilize appropriate hardware and software configured for wired and/or wireless communication with communication device 110 and/or service provider server 130. For example, in one embodiment, communication device 120 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Communication device 120 may be utilized by a recipient of an electronic message from communication device 110 to communication device 120. Although a communication device is shown, the communication device may be managed or controlled by any suitable processing device. Although only one communication device is shown, a plurality of communication devices may function similarly.

Communication device 120 of FIG. 1 contains an electronic messaging application 122, other applications 124, a database 126, and a communication module 128. Electronic messaging application 122 and other applications 124 may correspond to executable processes, procedures, and/or applications with associated hardware. In other embodiments, communication device 120 may include additional or different modules having specialized hardware and/or software as required.

Electronic messaging application 122 may correspond to one or more processes to execute modules and associated devices of communication device 120 to generate, send, receive, and/or reply to electronic communications, as well as establish timers for alerts to electronic communications and receive such alerts. In this regard, electronic messaging application 122 may correspond to specialized hardware and/or software utilized by communication device 120 to provide an interface to permit a user (e.g., the recipient) associated with communication device 120 to receive an electronic message transmitted by communication device 110 and/or alerts from service provider server 130, such as an email, text message, instant message, message through a social networking service or other online platform, or through another communication protocol, service, and/or technology (e.g., short range wireless communications using a communication protocol such as Bluetooth, Bluetooth low energy, etc.). Electronic messaging application 122 may receive incoming messages using one or more communication protocol and communication pathway, such as network communications and/or short range wireless communication. Electronic messaging application 122 may also generate messages for transmission to one or more other entities, including new electronic messages to communication device 110 and/or replies to previous messages from communication device 110. Electronic messaging application 122 may be implemented as a user interface enabling the user to enter user input to generate, view, and/or respond to received electronic communications. Electronic messaging application 122 may correspond to a specific communication technology, such as email, text messaging, etc. However, in other embodiments, electronic messaging application 122 may utilize a plurality of different communication protocols and technologies, and gather different types of received electronic communications. In various embodiments, electronic messaging application 122 may correspond to a general browser application configured to retrieve, present, and communicate information over the Internet (e.g., utilize resources on the World Wide Web) or a private network. For example, electronic messaging application 122 may provide a web browser, which may send and receive information over network 150, including retrieving website information, presenting the website information to the user, and/or communicating information to the website, including electronic communications and associated information. However, in other embodiments, electronic messaging application 122 may include a dedicated application of service provider server 130 or other entity (e.g., a merchant, payment provider, etc.), which may be configured to send and receive electronic communications. Electronic messaging application 122 may be utilized to establish and/or maintain a user account, payment account, digital wallet, and/or other online with service provider server 130.

As discussed herein, electronic messaging application 122 may further be used to establish a timer for use in reminding a sender of communication device 120 and/or recipient of communication device 110 of a sent electronic message from communication device 110 to communication device 120. For example, if the recipient of communication device 120 fails to respond, view, or otherwise acknowledge the electronic message by the end of a timer, the recipient may be notified through an alert to communication device 120. In various embodiments, the sender of communication device 120 may also be notified. In order to establish the timer, including preferences for the specific timer and/or a plurality of timers, the sender may provide a timer initiation command in the electronic message generated by the sender using electronic messaging application. The timer initiation command may correspond to a network address, such as an email address, messaging name, Uniform Resource Location (URL), or other identifier for service provider server 130, including a token identifying service provider server 130. The timer initiation command may be placed in an address field, subject line, body, signature line, and/or attachment of the message. In other embodiments, the recipient for communication device 120 may utilize electronic messaging application 122 to establish the timer, for example, by transmitting a follow-up message to service provider server 130 after receiving the messaging from communication device 110. Service provider server 130 may process the message and/or timer initiation command, as discussed herein. In various embodiments, service provider server 130 may monitor the electronic communications of electronic messaging application 122 to determine the timer, as discussed herein.

In various embodiments, electronic messaging application 122 may utilize any communication pathway to receive the message from communication device 110, including network communications and short range wireless communications. For example, service provider server 130 may monitor and/or receive the message through communication monitoring of communication device 120 and/or communication device 110. Electronic messaging application 122 may further be used to set preferences for the timer for the message and/or for a plurality of timer, for example, using an online website and/or portal and application interface. In other embodiments, electronic messaging application 122 may receive user input for user information and/or determine user information for preferences, and transmit the user information to service provider server 130. Electronic messaging application 122 may be utilized to alert the recipient of communication device 120 through a received alert from service provider server 130. The alert may be sent using a communication protocol and pathway, as explained herein.

In various embodiments, communication device 120 includes other applications 124 as may be desired in particular embodiments to provide features to communication device 120. For example, other applications 124 may include security applications for implementing client-side security features, programmatic client applications for interfacing with appropriate application programming interfaces (APIs) over network 150, or other types of applications. Other applications 124 may also include additional communication applications where not provided by electronic messaging application 122, such as email, texting, voice, and IM applications that allow a user to send and receive emails, calls, texts, and other notifications through network 150. In various embodiments, other applications 124 may include financial applications, such as banking, online payments, money transfer, or other applications. Other applications 124 may also include other location detection applications, such as a mapping, compass, and/or GPS application, which may be used to determine a location for the user that is communicated to payment provider server 130. Other applications may include social networking applications and/or merchant applications. Other applications 124 may include device interfaces and other display modules that may receive input and/or output information. For example, other applications 124 may contain software programs, executable by a processor, including a graphical user interface (GUI) configured to provide an interface to the user.

Communication device 120 may further include database 126 stored to a transitory and/or non-transitory memory of communication device 120, which may store various applications and data and be utilized during execution of various modules of communication device 120. Thus, database 126 may include, for example, IDs such as operating system registry entries, cookies associated with electronic messaging application 122 and/or other applications 124, IDs associated with hardware of communication device 120, or other appropriate IDs, such as IDs used for payment/user/device authentication or identification. Database 126 may include electronic communications, including sent and received messages having timers and alerts received on expiration of set timers, which may be received from communication device 110 and/or service provider server 130.

Communication device 120 includes at least one communication module 128 adapted to communicate with communication device 110 and/or service provider server 130. In various embodiments, communication module 128 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 130 may be maintained, for example, by a communication service provider, which may provide messaging, timed reminders or alerts, and other communication services to the sender associated with communication device 110 and the recipient associated with communication device 120. In this regard, service provider server 130 includes one or more processing applications which may be configured to interact with communication device 110, communication device 120, and/or another device/server to facilitate establishing one or more timers to alert senders and/or recipients of unacknowledged electronic messages. In one example, service provider server 130 may be provided by PAYPAL®, Inc. of San Jose, Calif., USA. However, in other embodiments, service provider server 130 may be maintained by or include a telephonic service provider, social networking service, and/or other service provider, which may provide messaging and message alert services to the user.

Service provider server 130 of FIG. 1 includes communication monitoring application 140, a response timer application 132, other applications 134, a database 136, and a network interface component 138. Communication monitoring application 140, response timer application 132, and other applications 134 may correspond to executable processes, procedures, and/or applications with associated hardware. In other embodiments, service provider server 130 may include additional or different modules having specialized hardware and/or software as required.

Communication monitoring application 140 may correspond to one or more processes to execute modules and associated specialized hardware of service provider server 130 to monitor and/or receive electronic communications to determine whether the electronic communications require a timer to alert a sender or recipient at the expiration of the time period to respond, view, or otherwise acknowledge one or more electronic messages in the communications. In this regard, communication monitoring application 140 may correspond to specialized hardware and/or software to monitor or receive a stream of electronic communications, including email, text, voice, instant messaging, social networking, or other electronic communications. Once received, communication monitoring application 140 may determine whether any messages in the communication stream include a request to establish a timer for the message, such as a timer initiation command. As discussed herein, the command may include an address in an address field, or may include code, text, attachments, or other data otherwise associated with the message. In other embodiments, communication monitoring application 140 may instead determine to establish a timer for the message based on the messages data or metadata. For example, if the message is a chain of un-replied messages, or if the metadata for the message shows it has not been acknowledged by the recipient, a timer may be initiated. In other embodiments, the subject line, content, and/or signature line may include a due date, response date, or other timeframe, where communication monitoring application may determine that the message requires a timer to alert the user of a response requirement prior to or by the time/date determined from the message data or metadata.

Communication monitoring application 140 may also determine preferences for timers, such as the time period of the timer, a destination for an alert at the end of the timer, and/or type of protocol for the alert. Such preferences may be determined based on user input provided by the user, as well as determined from the data and metadata of the message establishing the timer. For example, a user may provide the preferences through one or more interfaces accessible for service provider server 130. Such interfaces may be accessible through a website and/or dedicated application, and a link for the interfaces may be provided in the message establishing the timer. However, in other embodiments, communication monitoring application 140 may determine the preferences using the data of the message. For example, a time period for a timer may be set based on the urgency and/or escalation of a message, such as if it is marked as urgent or whether the message has gone un-responded for multiple alerts. In other embodiments, the data may be used to determine a destination device/account and/or type of alert. Moreover, the metadata for such message may also affect the preferences, such as a time and/or account of origin and/or receipt of the message, a number of messages associated with the message, or other metadata. User information may also affect the preferences, such as information used to determine a best device or account to transmit an alert to at the expiration of a timer. Such user information may include locations, schedules, transaction histories, used devices/accounts, or other user information.

Response timer application 132 may correspond to one or more processes to execute modules and associated specialized hardware of service provider server 130 to receive and/or transmit information from communication device 110 for establishing timers to alert users (e.g., the sender of communication device 110 and/or the recipient of communication device 120) of response requirements for a sent or received electronic message. In this regard, response timer application 132 may correspond to specialized hardware and/or software to establish timers based on information monitored, received, and/or determined by communication monitoring application 140. The sender associated with communication device 110 may transmit an electronic message to communication device 120 for the recipient as previously discussed, where communication monitoring application 140 determines that a timer for response to the message should be set. Response timer application 132 may establish a timer, which has a time period at the end of which, response timer application 132 may transmit an alert to at least one of communication device 110 and communication device 120. The timer may be ended if the recipient utilizes communication device 120 to respond to the initial electronic message, view the message, or otherwise acknowledge the message. Additionally, the sender and/or recipient may end the timer utilizing a follow-up email, command, and/or by accessing response timer application 132 over network 150 using communication device 110 or communication device 120, respectively.

Response timer application 132 may further receive extensions or modifications to the timer from one or more of communication device 110 and/or communication device 120 through an interface provided by response timer application 132 and/or through follow-up messages or emails received by service provider server 130. Response timer application 132 may modify a timer for a message based on the received input. Thus, where a response is provided by the recipient associated with communication device 120 by the end of the initial or modified timer, response timer application1 132 may end the timer and process. However, where a response, view, or other acknowledgement of a message having a timer is not received by the end of the timer, response timer application 132 may instead transmit an electronic alert through a messaging account and/or device for at least one of the sender associated with communication device 110 and the recipient associated with communication device 120.

In various embodiments, response timer application 132 may utilize preferences and/or information determined by communication monitoring application 140 to determine a destination device and/or destination account for the electronic alert, as well as a messaging type or protocol for the electronic alert. Response timer application 132 may transmit the electronic alert based on the aforementioned information. Where the alert is not acted upon (e.g., viewed, responded to, or otherwise acknowledged), response timer application 132 may further utilize the preferences and/or communication monitoring application 140 to determine another destination device/account and/or electronic alert type/protocol. Additionally, response timer application 132 may set further alerts to send another reminder as an electronic alert where the recipient fails to respond to, view, or acknowledge the message and/or any further alerts for the message. Response timer application 132 may determine the timer's length, important (e.g., urgency), and other parameters based on the previous message and alerts. Thus, where multiple alerts are set, they may increase in urgency, frequency, and/or importance based on the lack of response by the recipient. Moreover, response timer application 132 may further notify a supervisor or other third party (such as a spouse, co-worker, family member, friend, or other person who are nearby the recipient (e.g., as determined by locations of smart phones of the recipient and the third party) and/or who may be able to reach the recipient), which may be determined from preferences, additional addresses in the message, or online resource, and in particular where the recipient fails to respond after multiple electronic alerts.

In various embodiments, service provider server 130 includes other applications 134 as may be desired in particular embodiments to provide features to payment provider server 134. For example, other applications 134 may include security applications for implementing server-side security features, programmatic client applications for interfacing with appropriate application programming interfaces (APIs) over network 150, or other types of applications. Other applications 134 may contain software programs, executable by a processor, including a graphical user interface (GUI), configured to provide an interface to the user when accessing payment provider server 134. In various embodiments where not provided by response timer application 132, other applications 134 may include connection and/or communication applications, as well as user account applications, which may be utilized by the sender associated with communication device 110 and/or the recipient associated with communication device 120 to send and receive messages.

Additionally, service provider server 130 includes database 136. As previously discussed, the entity corresponding to communication device 120 may establish one or more messaging and/or alert accounts with service provider server 130. Accounts in database 136 may include entity information, such as name, address, birthdate, payment/funding information, additional user financial information, and/or other desired user data. The entity may link to their respective accounts through an account, user, merchant, and/or device ID, as well as a generated token, which may be provided to communication device 110 and/or communication device 120 for use. Thus, when an ID is transmitted to service provider server 130, e.g., from communication device 110 and/or communication device 120, an account belonging to the entity may be found. Additionally, received messages, such as a stream of electronic communications, may be stored to database 136, as well as associated timers and electronic alerts.

In various embodiments, service provider server 130 includes at least one network interface component 138 adapted to communicate communication device 110 and/or communication device 120 over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

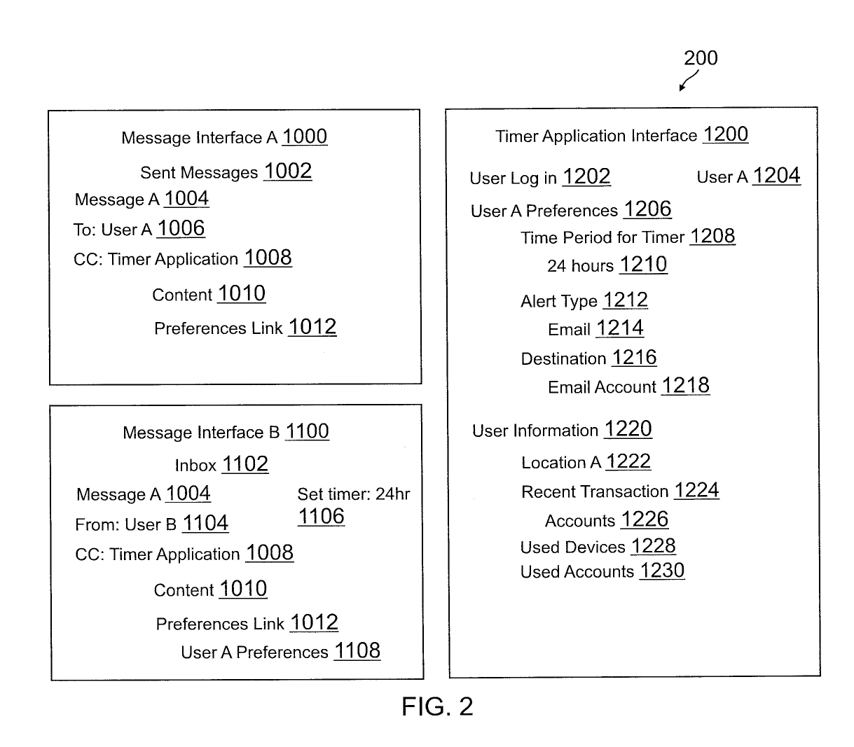

FIG. 2 is an exemplary environment displaying application interfaces for automated monitoring of electronic messaging for timed alerts of previously transmitted messages, according to an embodiment. Messaging application interface A 1000 may correspond to an interface of an application executed by a communication device, such as electronic messaging application 112 of communication device 110 in FIG. 1. Similarly, messaging application interface B 1100 may correspond to an interface of an application executed by a communication device, such as electronic messaging application 122 of communication device 120 in FIG. 1. Moreover, timer application interface 1200 may correspond to an accessible interface of a server, for example, through a website and/or interface of a dedicated application. In this regard, timer application interface 1200 may be provided by a service provider application, such as response timer application 132 of service provider server 130 in FIG. 1.

In messaging interface A 1000, a user, such as a sender of an electronic message, may view an interface having sent messages 1002. Send messages 1002 may include the electronic message sent by the sender, such as message A 1004. Message A 1004 includes address fields used to transmit message A 1004. For example, a “To:” field is populated with user A 1006. In order to invoke a timer to send a reminder for message A 1004, a “CC:” field includes an address for timer application 1008 of a service provider. Message A 1004 may further include content 1010 for a recipient user. Moreover, message A 1004 includes a preferences link 1012, where the sender and/or recipient may establish preferences for the timer set through adding timer application 1008 to the address field.

Messaging interface B 1100 may correspond to an interface where another user, such as a recipient of the electronic message sent by the sender may view the electronic message. For example, messaging interface B 1100 includes an inbox 1102 having received communications, including message A 1004 from the sender. Message A 1004 includes address fields showing the sender in the “From:” field as user B 1104, as well as the address for timer application 1008. In various embodiments, message A 10044 further includes a set timer 1106 having a time period of “24HR.” Message A 1004 further includes content 1010, as well as the preferences link 1012 displaying user A preferences 1108 for recipient.

Timer application interface 1200 corresponds to a displayable interface, which may be accessed through preferences link 1012. Thus, as the recipient, user A 1204, logs in through user login 1202, user A 1204 may establish preferences for one or more timers. For example, user A preferences 1206 includes a timer period for a timer 1208, such as 24 hours 1210. Additionally, user A preferences 1206 includes an alert type 1212, which may correspond to the protocol to send an electronic alert (e.g., email 1214). User A preferences 1206 further includes a destination 1216, such as a destination device or account, which is shown as email account 1218. Timer application interface 1200 may further include user information 1220 that may be used to determine various preferences, including a location A 1222, a recent transaction 1224 through accounts 1226, user devices 1228, and used accounts 1230.

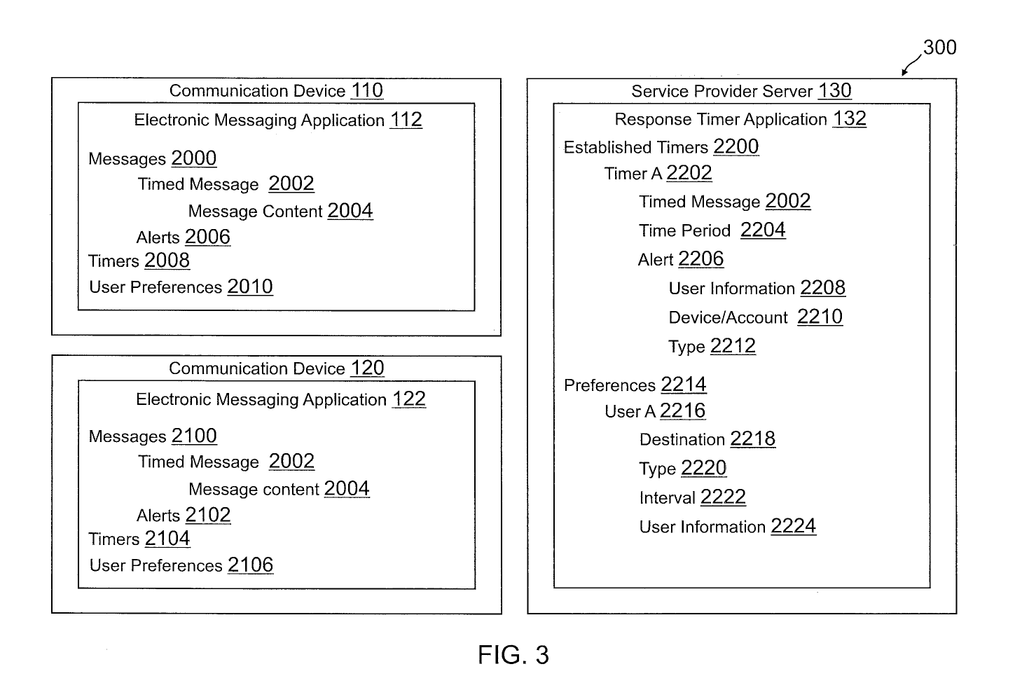

FIG. 3 is an exemplary system environment having a multiple communication devices and a service provider for automated monitoring of electronic messaging for timed alerts of previously transmitted messages, according to an embodiment. Environment 300 of FIG. 3 includes a communication device 110, a communication device 120, and a service provider server 130 corresponding generally to the described devices and associated features found in system 100 of FIG. 1.

Communication device 110 executes an electronic messaging application 112 corresponding generally to the specialized hardware and/or software modules and processes described in reference to FIG. 1. In this regard, electronic messaging application 112 includes information for sent and received message. For example, electronic messaging application 112 includes data for messages 2000, which include a timed message 2002 having message content 2004. Additionally, electronic messaging application includes data for alerts 2006 received by communication device 110. In various embodiments, electronic messaging application 112 may include data for timers 2008, as well as processes to access and modify user preferences 2010.

Communication device 120 executes an electronic messaging application 122 corresponding generally to the specialized hardware and/or software modules and processes described in reference to FIG. 1. In this regard, electronic messaging application 122 includes information for sent and received message. For example, electronic messaging application 112 includes data for messages 2100, which include a timed message 2002 having message content 2004 from communication device 110. Additionally, electronic messaging application includes data for alerts 2102 received by communication device 120, which may include an alert for timed message 2002. In various embodiments, electronic messaging application 122 may include data for timers 2104, as well as processes to access and modify user preferences 2106.

Service provider server 130 executes a response timer application 132 corresponding generally to the specialized hardware and/or software modules and processes described in reference to FIG. 1. In this regard, response timer application 132 includes information that may be used to establish and execute times, as well as set preferences for timers. For example, response timer application 132 includes established timers 2200, which includes a timer A 2202 for timed message 2002 transmitted from communication device 110 to communication device 120. Timer A 2202 includes a time period 2204 for time A 2202, which causes an alert 2206 to be transmitted to one or more of communication device 110 and communication device 120 at the expiration of time period 2204. Alert 2206 may include user information 2208 for use in transmitting alert 2206, as well as a destination device/account 2210 and a type 2212 for alert 2206. Response timer application 132 may further include preferences 2214, for example, preferences for user A 2216, which may include a destination 2218 for an alert, as well as a type 2220 for the alert, an interval 2222 for a timer, and user information 2224.

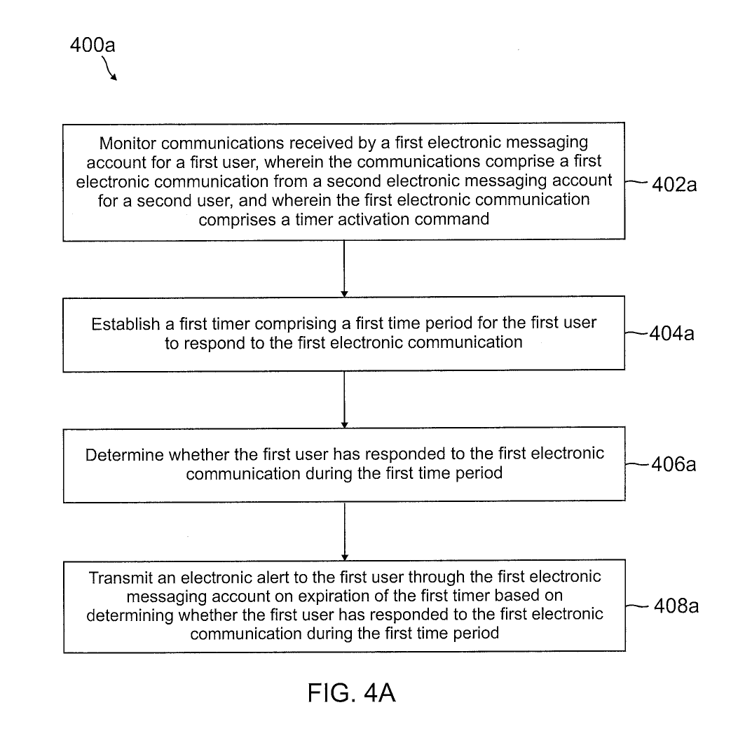

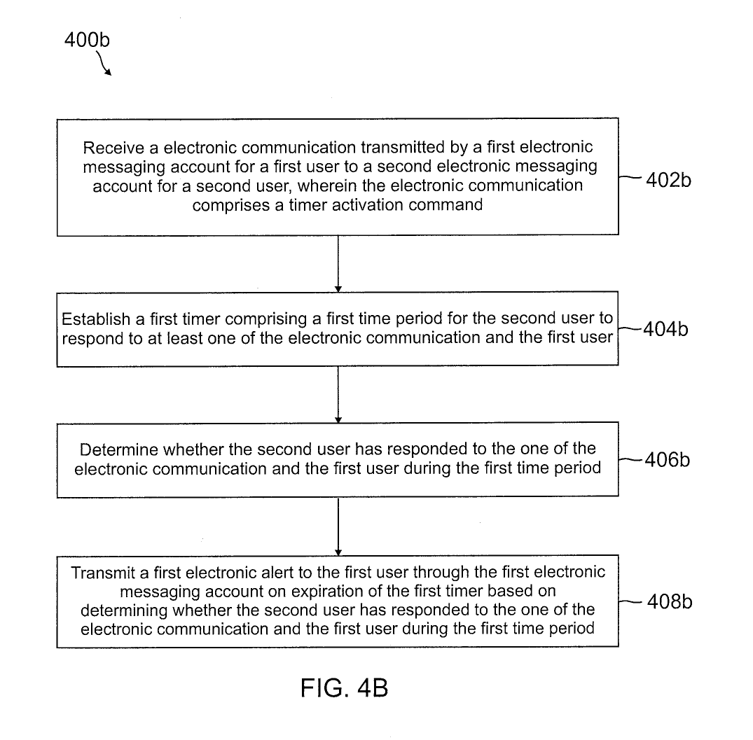

FIG. 4A is an exemplary process flowchart for automated monitoring of electronic messaging for timed alerts of previously transmitted messages for a recipient, according to an embodiment. Note that one or more steps, processes, and methods described herein may be omitted, performed in a different sequence, or combined as desired or appropriate.

At step 402a, communications received by a first electronic messaging account for a first user are monitored, wherein the communications comprise an electronic communication from a second electronic messaging account for a second user, and wherein the electronic communication comprises a timer activation command. The timer activation command may comprise an electronic address of the system in an address field of the first electronic communication, and wherein the monitoring the communications comprises receiving, by the system, the first electronic communication at the electronic address. The first electronic communication may comprise an email, wherein the first electronic messaging account and the second electronic messaging account comprise email accounts. The timer activation command may comprise an electronic address of the system in a body of the first electronic communication, and wherein the monitoring the communications comprises detecting, by the system, the electronic address in the body of the first electronic communication.

A timer comprising a first time period for the first user to respond to the electronic communication is established, at step 404a. The first electronic communication may comprise an urgency level, wherein at least one of the first timer and the first time period depend on the urgency level. At step 406a, it is determined whether the first user has viewed or responded to the electronic communication during the first time period. Thus, at step 408a, an electronic alert is transmitted to the first user on expiration of the timer. Transmitting the electronic alert may further comprise transmitting the first electronic alert to a supervisor for the first user on expiration of the first timer.

In various embodiments, a second electronic communication is received from the first electronic messaging account of the first user, wherein the second electronic communication comprises preferences for the first timer, and wherein the preferences comprises at least one of an amount of time for the first time period, a type for the electronic alert, and a destination account or a destination device for the electronic alert. A request to cancel the timer prior to expiration of the first time period may be received, and the timer may be canceled to prevent transmitting the electronic alert to the first user through the first electronic messaging account on the expiration of the first timer. A request to update the timer with a second time period may be received, and the timer may be updated to the second time period.

FIG. 4B is an exemplary process flowchart for automated monitoring of electronic messaging for timed alerts of previously transmitted messages for a sender. Note that one or more steps, processes, and methods described herein may be omitted, performed in a different sequence, or combined as desired or appropriate.

At step 402b, an electronic communication transmitted by a first electronic messaging account for a first user to a second electronic messaging account for a second user is received, wherein the electronic communication comprises a timer activation command. The timer activation command may comprise an email address for one of the system and a timer application of the system, and wherein the email address is added to an address field of the electronic communication. A first timer comprising a first time period for the second user to respond to at least one of the electronic communication and the first user is established, at step 404b. At step 406b, it is determined whether the second user has viewed or responded to the one of the electronic communication and the first user during the first time period. A first electronic alert is transmitted to the first user on expiration of the first timer based on determining whether the second user has viewed or responded to the one of the electronic communication and the first user during the first time period, at step 408b. Transmitting the first electronic alert may further comprise transmitting the first electronic alert to the second user on expiration of the first timer.

In various embodiments, a request to change the first time period to a second time period is received, and the first timer is updated to the second time period. In further embodiments, a request to establish a second timer having a second time period is received. The second timer may be updated, and it may be determined whether the second user has viewed or responded to the one of the electronic communication and the first user during the second time period. Thus, a second electronic alert is transmitted to the first user through the first electronic messaging account on expiration of the second timer based on determining whether the second user has viewed or responded to the one of the electronic communication and the first user during the second time period.

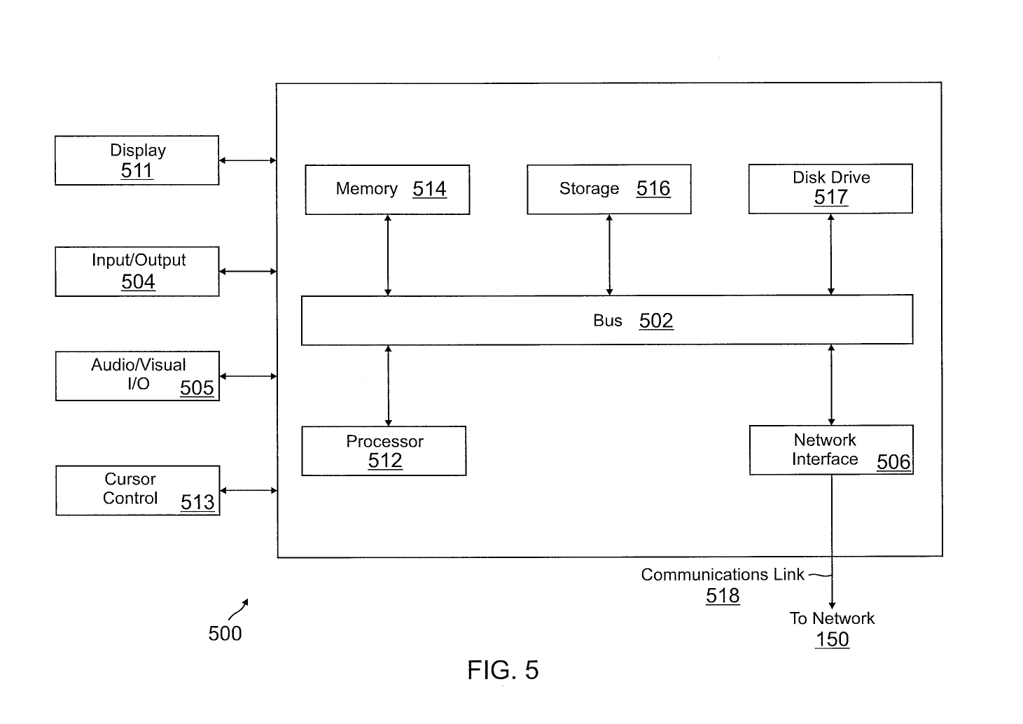

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many foams, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
monitoring communications received by a first electronic messaging account for a first user, wherein the communications comprise a first electronic communication from a second electronic messaging account for a second user, and wherein the first electronic communication comprises a timer activation command;
establishing a first timer comprising a first time period for the first user to respond to the first electronic communication;
determining whether the first user has viewed or responded to the first electronic communication during the first time period; and
transmitting an electronic alert to the first user on expiration of the first timer based on determining whether the first user has viewed or responded to the first electronic communication during the first time period.

2. The system of claim 1, wherein the timer activation command comprises an electronic address of the system in an address field of the first electronic communication, and wherein the monitoring the communications comprises receiving, by the system, the first electronic communication at the electronic address.

3. The system of claim 2, wherein the first electronic communication comprises an email, and wherein the first electronic messaging account and the second electronic messaging account comprise email accounts.

4. The system of claim 3, wherein the electronic address comprises one of a Uniform Resource Locator address and an email account address.

5. The system of claim 1, wherein the timer activation command comprises an electronic address of the system in a body of the first electronic communication, and wherein the monitoring the communications comprises detecting, by the system, the electronic address in the body of the first electronic communication.

6. The system of claim 1, wherein the operations further comprise:
receiving a second electronic communication from the first electronic messaging account of the first user, wherein the second electronic communication comprises preferences for the first timer, and wherein the preferences comprises at least one of an amount of time for the first time period, a type for the electronic alert, and a destination account or a destination device for the electronic alert.

7. The system of claim 1, wherein the first electronic communication comprises a Uniform Resource Locator to an website interface or application interface to establish preferences for the first timer, and wherein the preferences comprises at least one of an amount of time for the first time period, a type for the electronic alert, and a destination account or a destination device for the electronic alert.

8. The system of claim 1, wherein the operations further comprise:
receiving a request to cancel the timer prior to expiration of the first time period; and
cancelling the timer to prevent transmitting the electronic alert to the first user through the first electronic messaging account on the expiration of the first timer.

9. The system of claim 1, wherein the operations further comprise:
receiving a request to update the timer with a second time period; and
updating the timer to the second time period.

10. The system of claim 1, wherein the first electronic communication comprises an urgency level, and wherein at least one of the first timer and the first time period depend on the urgency level.

11. The system of claim 1, wherein the transmitting the electronic alert further comprises transmitting the first electronic alert to a supervisor for the first user on expiration of the first timer.

12. A method comprising:
determining an electronic message was sent from a sender to a device of a recipient;
determining the electronic message is associated with an alert when the recipient has not performed an action with the electronic message within a predetermined amount of time;
determining the recipient has not performed the action within the predetermined amount of time; and
transmitting the alert electronically to a user device related to the recipient.

13. The method of claim 12, wherein the electronic message comprises a link to an interface to establish preferences for the timer, and wherein the preferences comprises at least one of an amount of time for the predetermined amount of time, a type for the alert, and a destination account for the alert.

14. The method of claim 12, wherein the device of the recipient and the user device of the recipient are a same device.

15. The method of claim 12, wherein the predetermined amount of time is based on at least one of preferences set by the sender, content of the electronic message, and information about the recipient, and wherein the information about the recipient comprises at least one of calendar information for the recipient and device information for the user device of the recipient.

16. A system comprising:
a non-transitory memory; and
one or more hardware processors coupled to the non-transitory memory and configured to read instructions from the non-transitory memory to cause the system to perform operations comprising:
receiving a electronic communication transmitted by a first electronic messaging account for a first user to a second electronic messaging account for a second user, wherein the electronic communication comprises a timer activation command;
establishing a first timer comprising a first time period for the second user to respond to at least one of the electronic communication and the first user;
determining whether the second user has viewed or responded to the one of the electronic communication and the first user during the first time period; and
transmitting a first electronic alert to the first user on expiration of the first timer based on determining whether the second user has viewed or responded to the one of the electronic communication and the first user during the first time period.

17. The system of claim 16, wherein the operations further comprise:
receiving a request to change the first time period to a second time period; and
updating the first timer to the second time period.

18. The system of claim 16, wherein the operations further comprise:
receiving a request to establish a second timer having a second time period;
establishing the second timer;
determining whether the second user has viewed or responded to the one of the electronic communication and the first user during the second time period; and
transmitting a second electronic alert to the first user through the first electronic messaging account on expiration of the second timer based on determining whether the second user has viewed or responded to the one of the electronic communication and the first user during the second time period.

19. The system of claim 16, wherein the transmitting the first electronic alert further comprises transmitting the first electronic alert to the second user on expiration of the first timer.

20. The system of claim 16, wherein the timer activation command comprises an email address for one of the system and a timer application of the system, and wherein the email address is added to an address field of the electronic communication.
